(19) United States
(12) Patent Application Publication
(10) Pub. No.: US 2017/0069213 A1
(43) Pub. Date: Mar. 9, 2017

(54) METHOD OF FLIGHT PLAN FILING AND CLEARANCE USING WIRELESS COMMUNICATION DEVICE

(71) Applicant: Raytheon Company, Waltham, MA (US)

(72) Inventors: Michael D. Thomas, Shrewsbury, MA (US); Kaiser Siddiqui, Lake Oswego, OR (US)

(21) Appl. No.: 14/845,959

(22) Filed: Sep. 4, 2015

(51) Int. Cl. G08G 5/00; H04W 4/14

(52) U.S. Cl. CPC G08G 5/003; H04W 4/14

(57) ABSTRACT

A method for obtaining flight plan clearance allows a general aviation pilot to negotiate flight plan clearance directly with an air navigation service provider (ANSP), exchanging digital data messages, with the pilot using a wireless communication device, such as a smartphone or a tablet computer. After an initial flight plan has been submitted, the pilot receives a message regarding clearance of the initial flight plan. Proposed changes to the flight plan may be received using the wireless communication device, which may be used to conduct further flight plan change negotiations via digital data messages. The messages may be sent from the wireless communication device may use a format that is suitable for use by the ANSP. There may be security features provided to ensure that flight plan changes are negotiated only by an authorized user, such as the pilot who submitted the original flight plan.

### FIELD OF THE INVENTION

The invention is in the field of air traffic control for aviation, specifically related to the process of submitting and negotiating flight plans and flight plan clearance.

### DESCRIPTION OF THE RELATED ART

In General Aviation (GA) pertinent to smaller aircraft, the pilots have numerous methods of filing flight plans to the Flight Service Station (FSS) and typically receive clearances through Clearance Delivery (CD) at bigger airfields or via the FSS at smaller airfields. The flight plans can be filed via smartphone or a tablet computer, such as an electronic flight bag.

In the vast majority of cases, the resulting clearance that would allow the pilot to fly the filed flight plan is made over the radio when the pilot is already sitting in the aircraft with engines running or is very close to starting engines. At this time any changes made to the flight plan will involve a time consuming and frustrating process to negotiate a cleared flight plan, delaying the pilot from becoming airborne. The cleared route may bear no resemblance to the filed route so significant work needs to be done by the pilot to work out whether the new route in the clearance still works in terms of fuel and reserve requirements.

### SUMMARY OF THE INVENTION

According to an aspect of the invention, a method of obtaining flight plan clearance includes the steps of: following submission of an initial flight plan, receiving in a wireless communication device (for example a portable wireless communication device) a response regarding revisions and/or clearance of the initial flight plan; and following the receiving, negotiating flight plan changes and/or clearance using the wireless communication device until an accepted flight plan clearance is obtained. The receiving and the negotiating include communicating with an air traffic control (ATC) automation system using digital messages.

According to another aspect of the invention, a method of handling flight plan clearance includes the steps of: receiving an initial flight plan; associating a wireless communication device with the initial flight plan; and following receiving and the associating, conducting subsequent flight plan clearance communications through digital messages sent to and received from the wireless communication device.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a schematic view illustrating communication according to an embodiment of the present invention.

FIG. 2 is a high-level flow chart illustrating a method of flight plan and clearance negotiation, according to an embodiment of the invention, from the standpoint of a pilot.

FIG. 3 is a high-level flow chart illustrating a method of flight plan and clearance negotiation, according to an embodiment of the invention, from the standpoint of an air traffic control (ATC) automation system.

FIG. 4 illustrates a first example sequence of operation according to the method of FIGS. 2 and 3.

FIG. 5 illustrates a second example sequence of operation according to the method of FIGS. 2 and 3.

FIG. 6 illustrates a third example sequence of operation according to the method of FIGS. 2 and 3.

FIG. 7 illustrates a fourth example sequence of operation according to the method of FIGS. 2 and 3.

FIG. 8 illustrates a fifth example sequence of operation according to the method of FIGS. 2 and 3.

FIG. 9 illustrates a sixth example sequence of operation according to the method of FIGS. 2 and 3.

FIG. 10 illustrates a seventh example sequence of operation according to the method of FIGS. 2 and 3.

FIG. 11 shows an example of message formatting on a flight plan revision message received by the wireless communication device.

### DETAILED DESCRIPTION

A method of obtaining flight plan clearance allows a general aviation pilot to negotiate flight plan clearance directly with an air navigation service provider (ANSP), exchanging digital messages, with the pilot using a wireless communication device, such as a smartphone or a tablet computer. After an initial flight plan has been submitted, the pilot receives a message regarding clearance of the initial flight plan. If, as is often the case, clearance for the initial flight plan is not granted, and changes to the flight plan are proposed, the pilot may receive the proposed changes using the wireless communication device, and may send messages, such as digital messages, to the ANSP accepting the proposed flight plan alteration, or proposed other possible changes. The messages sent from the wireless communication device may use a format that is suitable for use by the ANSP, for integration with other flight plans already in the system, with the messages for example able to be processed by the air traffic control (ATC) system (part of the ANSP) without human intervention (such as interpretation). There may be security features provided to ensure that flight plan changes are negotiated only by an authorized user, such as the pilot who submitted the original flight plan. The method allows the general aviation pilot to be able to bypass intermediaries, such as flight service stations, and communicate more directly with the ANSP. The resulting system and method may improve efficiency, saving pilot time and reducing fuel burned while waiting for clearance, and improve operation of the ATC automation system.

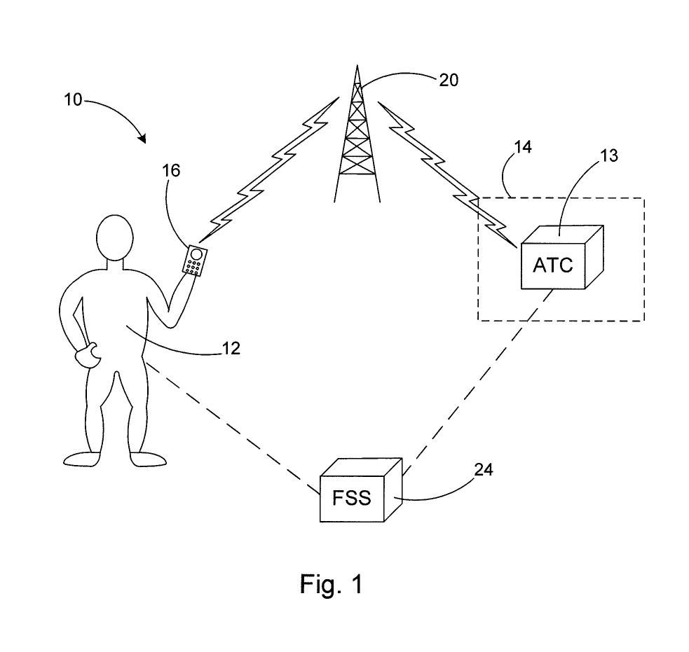

FIG. 1 shows an overview of a system 10 for allowing a pilot, such as a general aviation (GA) pilot 12, to communicate with an air traffic control (ATC) system 13, part of an air navigation service provider (ANSP), 14 directly, through use of a wireless communication device 16. The communication may be through some wireless network or system, such as a cellular phone network 20, and is direct in contrast to communication through an intermediary such as a flight service station (FSS) 24. The communication may be used to negotiate flight plan (FPL) changes to an initial flight plan that was submitted by the pilot, to produce a final cleared flight plan.

The wireless communication device 16 may be any of a variety of devices able to send and receive digital communications. Examples of wireless communication devices include smartphones, other cellular phones, tablet computers, electronic flight bags, laptop computers, and other types of computing/communication devices. Smartphone, as the term is used herein, refers to a cellular telephone with an integrated computer that is capable of running software applications. A tablet computer, as the term is used herein, refers to a mobile general-purpose computer with a touchscreen display, circuitry, and battery in a single unit, capable of running software applications. An electronic flight bag is an electronic information management device configured to aid a member of a flight crew to perform flight management tasks. A laptop computer is a mobile general-purpose computer, usually capable of running on battery power.

An ANSP is an organization that manages air traffic, and/or provides air traffic control (ATC), for a region or country. An example of an ANSP is the Federal Aviation Administration (FAA), which is responsible for providing ATC in the United States. An ANSP is responsible for managing flight plans submitted to it, for providing clearance for flight plans, and for negotiating changes to flight plans, if necessary. In the description that follows, ANSP will be used in some instances in general to refer to parts of the ANSP or the ATC automation system.

An FSS is an air traffic facility that provides information and services to pilots. An FSS does not manage flight plans, or provide clearance for flight plans.

Flight plans may be initially submitted any of a variety of ways, including through computer applications that allow submission of flight plans via an FSS. Flight plan clearance may be issued by in general by Clearance Delivery (a position that is part of the ATC automation system) at larger airfields, or by an FSS (at smaller airfields). Flight plan clearance also may be issued by ground controllers at an airport if there is no clearance delivery available, or if clearance delivery has not received clearance. In addition, clearance may be delivered by a tower controller when the tower controller is taking care of ground movements. At untowered airports it is usually the FSS that conveys clearance to aircraft. However negotiation of flight plan changes is often necessary close to take off time, and negotiations through an intermediary such as FSS can be time consuming, causing frustration and wasting time and fuel. The direct negotiation between the GA pilot and the ANSP provides an alternative that accomplishes flight plan negotiation directly, more quickly and more efficiently.

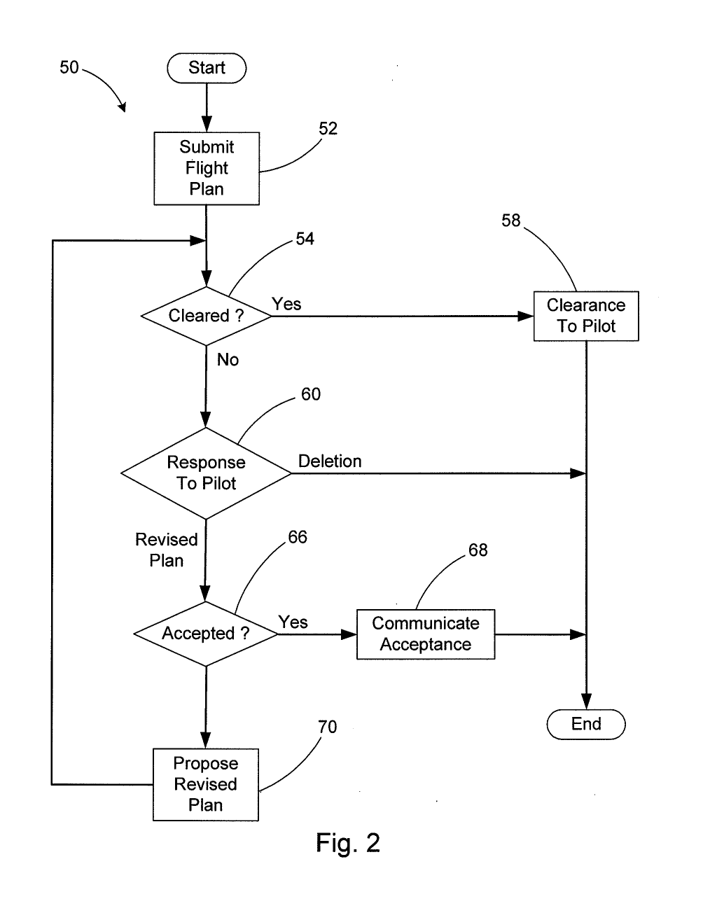

FIG. 2 shows a high-level flow chart of a method 50 for obtaining flight plan clearance. The flow chart is shown from the standpoint of the pilot. The initial flight plan is submitted in step 52. As noted above, the initial flight plan may be submitted in any number of known ways, for example using a smartphone or computer (e.g., a tablet or electronic flight bag) that has an application (app) installed on it that allows for entry and submission of a flight plan. The initial flight plan may be submitted well in advance of the flight time, for example hours or even days in advance of a flight. In addition, the initial flight plan may be submitted from any of a wide variety of physical locations via a variety of data submission methods, such as over a phone network (including a cellular phone network) or over a computer network, such as a worldwide computer network, for example the Internet.

In step 54 a decision is made whether to clear the initial flight plan. This decision is made by the ANSP. If the flight plan is cleared, then this clearance is communicated to the pilot in step 58. The acceptance (clearance) may be communicated to the pilot in any of a variety of ways. For example, the acceptance may be communicated to the pilot over the aircraft's radio. Alternatively, a digital message may be sent to the wireless communication device 16 (FIG. 1). Acceptance (clearance) of the flight plan by both the pilot 12 (FIG. 1) and the ANSP 14 (the ATC automation system (FIG. 1)) obviates the need to negotiate changes in the flight plan, ending the process.

If the flight plan is not initially accepted, a response is communicated from the ANSP 14 to the pilot in step 60. This communication may be by the same process as in step 58. However, it may be preferable for proposed changes to the flight plan to be communicated directly to the wireless communication device 16 (FIG. 1), as an alternative to or in addition to voice communication. In addition, it is preferred for further steps in the negotiation process to be carried out by communication between the wireless communication device 16 and the ANSP 14 (FIG. 1), such as in the form of digital data messages, for example as text messages. Messages sent by the wireless communication device 16 as part of the negotiation may be formatted for use by the ANSP 14, for example being in a form that is readable by the computer system of the ANSP 14, or is readily translatable (such as by computer or machine) into such a form. Errors in formatting can be corrected by a human operator. For example the messages may be in or may emulate a format set by the International Civil Aviation Organization (ICAO), such as ICAO 4444 format. Messages sent to the wireless communication device 16 may be in a form that can be utilized by the wireless communication device 16, for example by an app on the wireless communication device 16 that facilitates the negotiation process.

The response communicated in step 60 may take the form of proposed changes to the flight plan, or deletion of the plan from the system, such as because a maximum number of submissions has been reached, as described in greater detail below. If the plan is deleted from the system, the process ends and the pilot needs to begin the process anew by submitting a new flight plan.

Alternatively, if proposed changes to the flight plan are communicated in step 60, the pilot makes a decision in step 66 whether to accept the proposed revisions to the flight plan that were received in step 60. If so, the process ends with the pilot accepting the flight plan (step 68), the ANSP 14 (FIG. 1) acknowledging clearance, and the pilot 12 (FIG. 1) carrying out the flight.

If the pilot 12 (FIG. 1) does not accept the proposed revision, the pilot may propose another alternative in step 70, with further alterations to one or more aspects of the flight plan. This altered version need not necessarily be considered a new flight plan, but instead may be regarded as alteration of the previously-submitted flight plan. This proposed revision may be transmitted to the ANSP 14 (FIG. 1) in a digital message sent using the wireless communication device 16 (FIG. 1). The system then loops back to step 54, and an iterative process is then engaged in until a flight plan is approved (or until the plan is canceled, which may automatically occur if some predetermined number of allowed iterations is exceeded). This predetermined number of allowed iterations may be defined by the ANSP 14 as part of operational procedures of the ANSP 14.

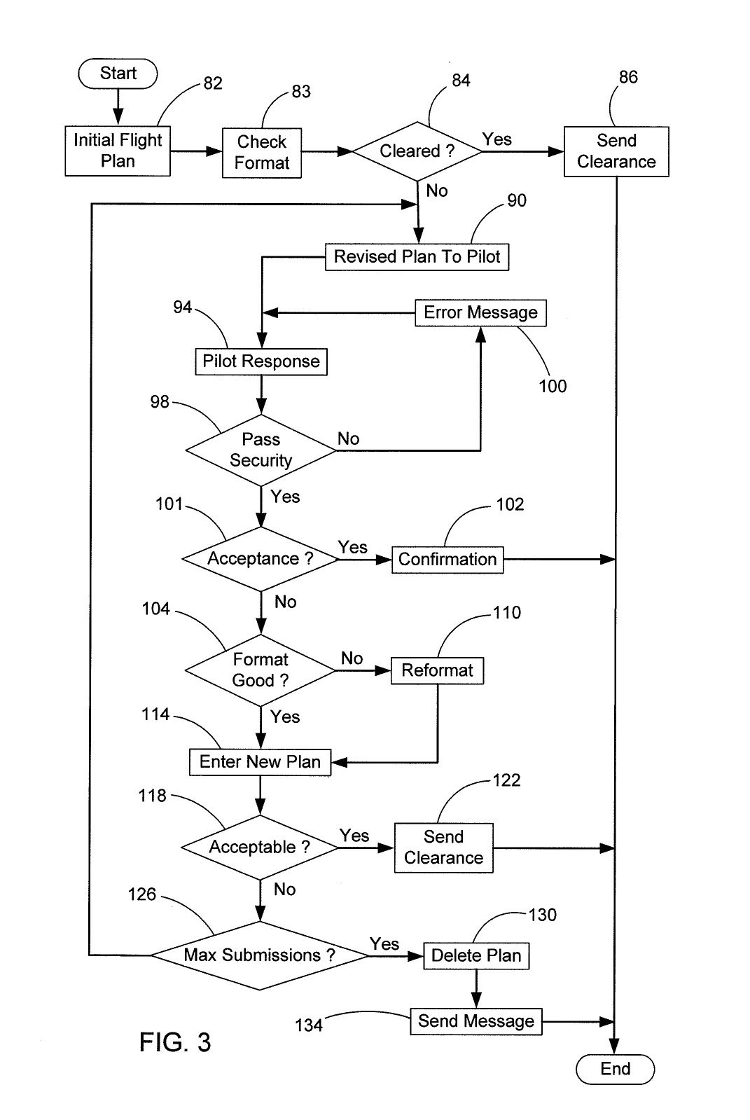

FIG. 3 shows a high-level flow chart of a method 80 from the standpoint of the ANSP 14 (FIG. 1), or at least a portion of the ANSP 14 that is the part of the ATC automation system that handles flight plans and clearances. In step 82 the ANSP 14 receives and processes an initial flight plan that is submitted by the pilot. This corresponds to step 52 shown in FIG. 2. The processing may include checking formatting of the submitted flight plan, and reformatting if necessary (step 83), as well as entering the flight plan into a part of the ATC automation system that handles flight plans, to prevent conflicts between cleared flight plans. In addition, the processing in step 82 may involve sending a confirmation to the filer of the flight plan. Information on the device used to submit the initial flight plan, such as a telephone number associated with a wireless communication device used to submit the plan, may be stored and associated with the flight plan (such as with the call sign of the flight plan), for security purposes, as described further below.

In step 84 a determination is made about whether the initial flight plan is cleared. Flight plans may be submitted hours or even days prior to flight, yet the decision regarding clearance may be held until close to the intended takeoff time. The clearance (acceptance) of the initial flight plan is based on numerous factors, including other flight plans that have been submitted, and deviations from those flight plans that occur for any of a number of reasons, such as weather or airport congestion, to name only two. It will be appreciated that general aviation flight plans may be a low priority relative to flight plans for commercial passenger and cargo aircraft. Therefore a high percentage of initial flight plans from general aviation pilots may require mediations. Nonetheless, for those initial flight plans that are accepted, a clearance message may be sent to the pilot in step 86. The clearance message may be sent in any of a number of ways, such as by a text message (or other message) to the wireless communication device 16 (FIG. 1) associated with the submittal of the initial flight plan, and/or by a message relayed through the FSS facility at the origin of flight. Once this clearance is accepted by the pilot 12 (FIG. 1), which may be done through the wireless communication device 16, the negotiation process comes to an end.

When the initial flight plan is not accepted, the pilot is informed in step 90 of proposed changes to the flight plan. The changes in the flight plan may involve alternations to the flight plan in any of a number of parameters, such as timing (e.g., departure time), routing, and altitude. The proposed changed flight plan may be sent to the pilot in a digital message (such as a text message) sent to a wireless communication device associated with the initial flight plan. In addition, the pilot may be alerted to the proposed changes in other ways.

After receiving the proposed flight plan changes, the pilot makes a response that is received in step 94. In step 98 a security check may be made, before processing the response. The security check may be made to prevent unauthorized submittals related to flight plans and/or proposed alterations of flight plans. One way of providing security is to require that the same device that was used to submit an initial flight also be used in any negotiations for changes in the flight plan. An initial flight plan may be associated with an identifier corresponding to the device 16 (FIG. 1) which was used to submit the original flight plan. For example, a smartphone has a unique telephone number associated with it, and that telephone number may be noted and associated with the initial flight plan when the initial flight plan is submitted (filed). The ATC automation system 13 (FIG. 1) may then communicate with the pilot using that telephone number, and reject incoming communications from devices other than the device associated with that telephone number. Alternatively or in addition, other identifiers may be used to allow communication with the same device that was used to submit the original flight plan. Further, it may be possible for the pilot to designate, as part of the initial flight plan submittal or a follow-up communication, a telephone number for use as a contact in any clearance negotiations.

Other sorts of methods of security may be used, as alternatives to or in addition to the identifiers described above. For example, the user may need to submit an alphanumeric password or other security code when proposing changes to an already submitted flight plan. The application on the wireless communication device 16 (FIG. 1) that is used to submit the original flight plan may receive and store such a code in response to submittal of the original flight plan, with the code for example being part of a confirmation sent to confirm receipt of the initial flight plan. The user (pilot) may have access to that code through the application on the wireless communication device, for example to enable negotiation of flight plan changes using another communication device.

If the security check in step 98 results in an error, an error message may be sent in step 100 to the device that was used to submit the response, indicated that the response was rejected by the system, with possibly other information included. The method then reverts to waiting for a response to the proposed flight plan changes sent in step 90.

If the incoming message (response) passes the security check of step 98 (which may be omitted if desired), then the message is checked in step 101 to see whether it is an acceptance of the changes to the flight plan proposed in step 90. If so, then a simple confirmation may be sent in step 102, and the flight plan is cleared, ending the process.

If the pilot does not accept the proposed changes to the flight plan, then the further (or different) changes proposed are checked in step 104 for proper syntax and/or formatting. The message may be configured to have a format corresponding to or emulating a standard format for flight plan submissions to the ANSP 14 (FIG. 1). For example the message may be formatted in an emulated aeronautic fixed telecommunications network (AFTN) format. The message format of AFTN messages is defined in International Civil Aviation Organization (ICAO) Annex 10 Aeronautical Telecommunications Volume II. AFTN messages generally consist of a heading, the message text and a message ending, all following defined formats. If the formatting is incorrect, then the message can be reformatted in step 110, such as by a human operator, for example an operation system specialist (OSS). The OSS may be provided with information concerning the method of submittal of the flight plan, for example indicating that the flight plan was submitted via text message. This indication may be used to indicate the urgency of such a message, since such revisions from a GA pilot would indicate that the submittal is very near to flight time. Such messages may be placed in a separate queue for priority handling by the OSS.

The correctly-formatted revised proposed flight plan is then entered into the ATC automation system 13 (FIG. 1), in step 114. The revised flight plan may be treated in the ATC automation system 13 like other proposed revised flight plans that are submitted by other operators, and/or using other channels. In step 118 a determination is made whether the proposed revised flight plan is acceptable, in view of factors such as the flight plans that have already been cleared. This determination may have some similarity to the determination made for the initial flight plan in step 84, described above. If the proposed revised plan is acceptable, clearance is sent in step 122, in a manner that may be similar to the communication of a cleared flight plan that was described above with regard to step 86.

If further changes are still needed, then a check may be made in step 126 whether the pilot has exceeded a maximum number of submissions for revisions of the flight plan. This step, which may be omitted if desired, keeps the pilot from submitting more than a predetermined number of changes, such as providing a maximum of four submissions of revised proposed flight plans. If the maximum number of allowed revisions is exceeded, then the flight plan is deleted in step 130, and the pilot is informed of the deletion in step 134, such as by a digital message to the wireless communication device.

If further changes are still allowed, then the method reverts to step 90 of further changes to the flight plan that would be acceptable to the ATC. The pilot may accept, or make other proposed revisions, continuing the negotiation.

It will be appreciated that other steps may be performed, and that the steps above may be performable in a different order from what is described above. The communications between the pilot 12 (FIG. 1) and the ANSP 14 (FIG. 1) may be primarily through the pilot's wireless communication device 16 (FIG. 1), but alternatively or in addition other communication methods may be used in some of the steps.

Other functions may be available to a pilot. For example, the pilot may be able to send a message to cancel a previously-submitted flight plan or a pending proposed revised flight plan, or to revise a previously-submitted plan.

As noted above, the digital messages used in the negotiation may be text messages sent from and to the wireless communication device 16 (FIG. 1). Messages sent to the wireless communication device may be simple and intuitive. For example, a text message FILED may be used to confirm that an initial or proposed flight plan has been received, PEND may be used to indicate that a message is being examined by an OSS or other ATC personnel (or otherwise is pending without being accepted or canceled), CHG+FPL may be used to indicate a change in flight plan by the ATC automation system, FPL CANCELED (or CNL) may be used to indicate that the flight plan has been canceled.

Table 1 shows various flight plan states and actions of the flight plan negotiation process:

TABLE 1

| | | ATC automation | | | Flight Plan State | Msg to Pilot from ATC |
|---|---|---|---|---|---|---|
| GA Pilot (via App) | | system | | | (in ATC System) | System (to App) |
| Pilot sends text | | ATC System receives | | | | |
| message FPL to ATC | | FPL: | | | | |
| System | | 1) | If Good - ATC | | 1) FILED | 1) FILED |
| | | | System accepts | | | |
| | | | FPL | | | |
| | | 2) | If Bad - Reject | | 2) PEND | 2) PEND |
| | | | to OSS | | | |
| | | 3) | OSS fixes and | | 3) FILED | 3) FILED |
| | | | FPL accepted | | | |
| | | ATC System changes | | | PEND | Pilot receives FPL |
| | | the FPL | | | | Change: |
| | | | | | | CHG + FPL (change |
| | | | | | | highlighted) |
| Pilot receives change: | | | | | | |
| 1) | Accept | 1) | ATC System | | 1) FILED | 1) FILED |
| | | | receives Accept | | | |
| 2) | Amends FPL and | 2) | ATC System | | | |
| | sends ICAO | | receives the CHG | | | |
| | format CHG | | message: | | | |
| | message | | a) | If Good - ATC | a) FILED | a) FILED |
| | | | | System accepts | | |
| | | | | FPL | | |
| | | | b) | If Bad - Reject | b) PEND | b) PEND |
| | | | | to OSS | | |
| | | | c) | OSS fixes and | c) FILED | c) FILED |
| | | | | FPL accepted | | |

| | | | |
|---|---|---|---|
| Maximum number of | ATC System receives | CANCEL | FPL CANCELED |
| attempts exceeded: | the CHG message, | | |
| Amends FPL and sends | determines maximum | | |
| ICAO format CHG | number of attempts | | |
| message | exceeded. | | |
| Pilot sends ICAO | ATC System receives | CANCEL | FPL CANCELED |
| format CNL message to | the CNL message. | | |
| ATC System | | | |

The flight plan status indicates the status and acceptance of flight plans prior to clearance.

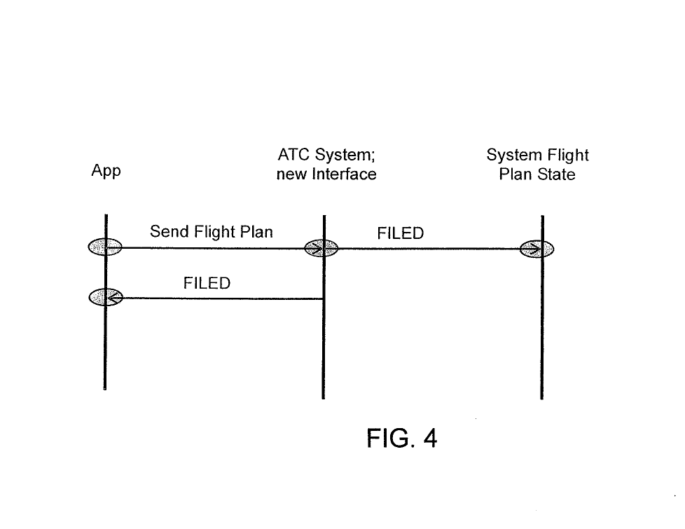

What follows now are some examples of flight plan negotiation processes. FIG. 4 shows a sample of a situation where the initial flight plan is accepted by the ATC automation system 13 (FIG. 1). The flight plan state in the ATC automation system 13 is marked as FILED, and a message indicating this is sent to the pilot 12 (FIG. 1).

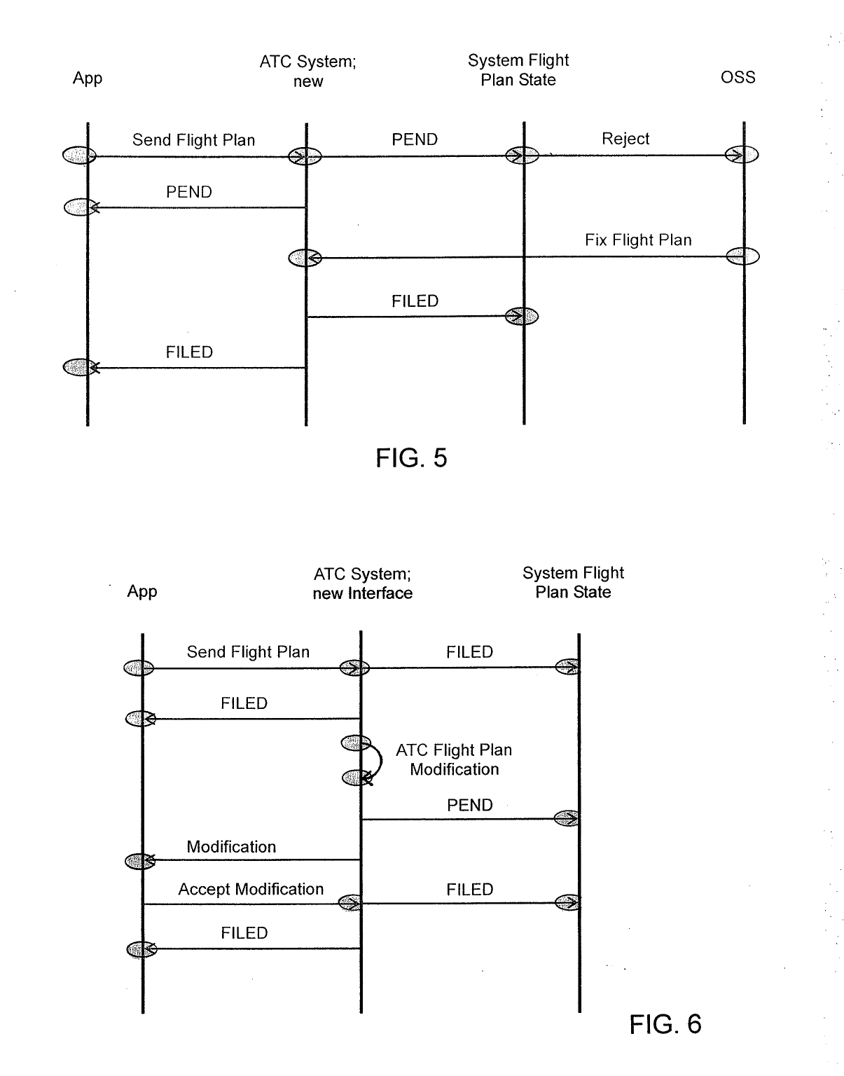

FIG. 5 shows a situation where the initial flight plan has errors (such as formatting or syntax errors) that are corrected by an OSS prior to that flight plan being accepted. A PEND status is applied to the submitted plan prior to its modification by the OSS, and a message to that effect is sent to the pilot. After the flight plan is fixed by the OSS, it is accepted in the ATC automation system, given a FILED status, and this acceptance is communicated to the pilot.

FIG. 6 shows a situation where a flight plan is initially entered into the ATC automation system 13 (FIG. 1) as FILED, but later has to be modified. The plan's status within the ATC automation system 13 is changed from FILED to PEND, and a message containing the modification is sent to the pilot. In the illustrated situation the pilot accepts the modification through a digital message, and the modified flight plan once again has the FILED state within the ATC automation system 13. A confirmation of the FILED state is sent to the pilot 12 (FIG. 1), through the wireless communication device 16 (FIG. 1).

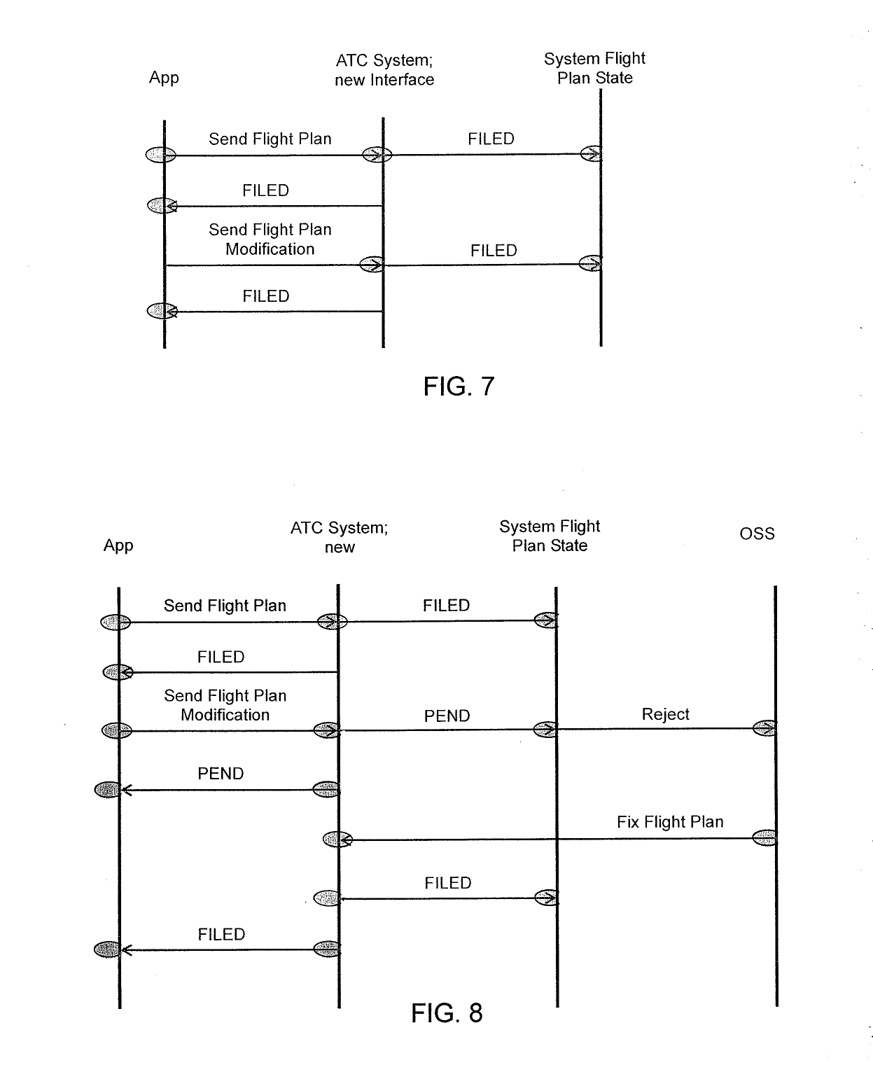

FIG. 7 shows a situation where an initial flight plan is accepted, being indicated within the ATC automation system 13 (FIG. 1) as FILED, but then the pilot 12 (FIG. 1) sends a modification to that flight plan. In the illustrated chain of events this modified plan is also accepted and accorded FILED status within the ATC automation system 13, and a message confirming this is sent to the pilot.

In the situation shown in FIG. 8, in contrast to the one of FIG. 7, the modified flight plan submitted after acceptance of an initial flight plan is rejected, being given a PEND state until it is fixed by an OSS. Thereafter it is accepted, and given a FILED state. PEND and FILED messages are sent to the pilot 12 (FIG. 1) to keep him or her apprised of the progress of the flight plan.

In addition to the flight plan states shown in Table 1, and the examples of FIGS. 5-8, the system employs a series of clearance states used in the process of obtaining clearance for takeoff using preciously-submitted and/or modified flight plans. The clearance negotiation may be carried out by a suitable interface that is part of the ATC automation system 13 (FIG. 1). Table 2 shows a summary of possible clearance states:

TABLE 2

| | | | Clearance | Msg to Pilot |
|---|---|---|---|---|
| | | | State | from ATC |
| ATC automation | | | (in ATC | System |
| system | GA Pilot (via App) | | System) | (to App) |
| ATC System | Pilot receives | | | |
| sends | Clearance: | | | |
| as-filed or | 1) | If Acceptable - | 1) ACTIVE | 1) ACTIVE |
| alternative | | Pilot accepts | | |
| Clearance | | the clearance | | |
| to pilot. | 2) | If unacceptable - | 2) PEND | 2) PEND |
| | | Pilot rejects | | |
| | | the clearance | | |
| ATC System | Pilot receives | | | |
| sends | alternative | | | |
| (additional) | Clearance: | | | |
| alternative | 1) | If Acceptable - | 1) ACTIVE | 1) ACTIVE |
| Clearance to | | Pilot accepts | | |
| pilot. | | the clearance | | |
| | 2) | If unacceptable - | 2) PEND | 2) PEND |
| | | Pilot rejects | | |
| | | the clearance | | |
| ATC System | Pilot receives | | | |
| sends final | alternative | | | |
| alternative | Clearance: | | | |
| Clearance to | 1) | If Acceptable - | 1) ACTIVE | 1) ACTIVE |
| pilot. | | Pilot accepts | | |
| | | the clearance | | |
| | 2) | If unacceptable - | 2) FPL - | 2) FPL AND |
| | | Pilot rejects | CANCEL | CLEARANCE |
| | | the clearance | Clearance - | CANCELED |
| | | | CANCEL | |

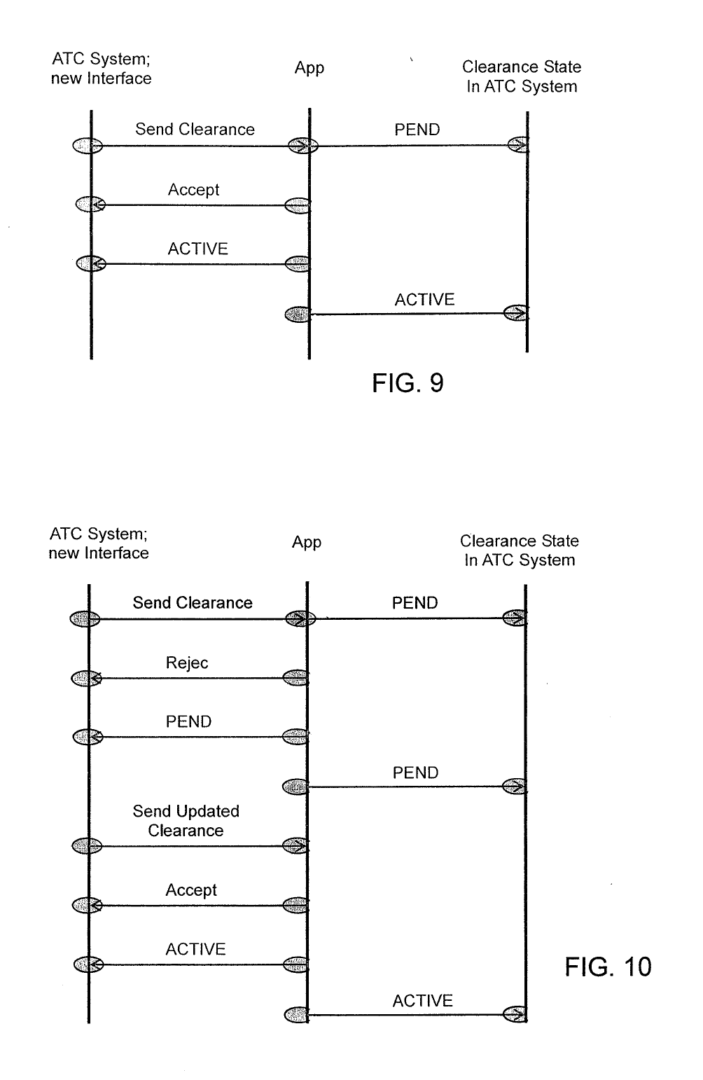

FIG. 9 shows a simple example where the ATC automation system 13 (FIG. 1) sends a clearance message to the pilot (represented in FIG. 9 as an application (“App”) run on a wireless communication device), maintaining the clearance state as pending (PEND) until a response is received from the pilot 12 (FIG. 1), such as sent via the wireless communication device 16 (FIG. 1). The clearance message that is sent to the pilot may involve a flight plan clearance that is for the as-filed flight plan, or is for an alternative clearance, a clearance that gives an alternate routing, but one that still corresponds with the already-submitted flight plan. Once the pilot 12 accepts the clearance, the clearance state is changed to ACTIVE, and a confirming message is sent to the pilot 12.

FIG. 10 shows a situation where the initial clearance is rejected by the pilot, followed by a proposed alternative clearance being sent to the pilot 12 by the ATC system. This situation may arise where the pilot's circumstances have changed since the filing of the initial flight plan, or when changes have been made for the initial clearance sent to the pilot 12. The clearance state in the ATC automation system remains PEND until a proposed alternative clearance is sent to the pilot 12 by the ATC system, and is accepted by the pilot 12. If the pilot 12 continues to reject successive alternative clearances that are presented by the ATC system, then eventually the flight plan can be canceled, as indicated in the last row of Table 2. In addition, if no alternative clearance is available, for example due to traffic constraints, then the flight plan could be canceled, with an explanation to the pilot 12, to allow the pilot 12 to file a new flight plan with an alternative routing.

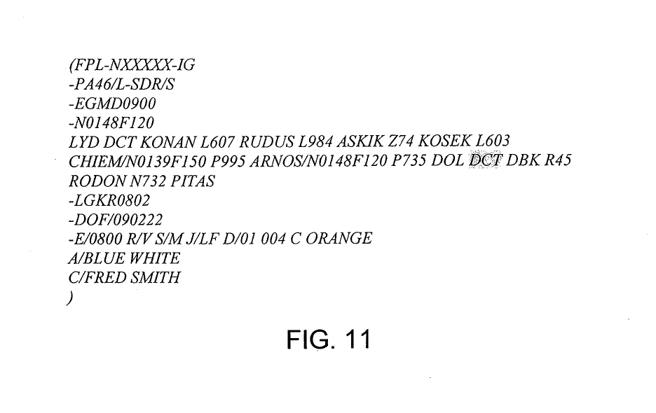

FIG. 11 shows an example of a flight plan in an AFTN flight plan format. The wireless communication device 16 (FIG. 1) could allow the pilot 12 (FIG. 1) to enter the flight plan on the wireless communication device 16 in ICAO 4444 format (for example), with the ATC automation system 13 (FIG. 1) receiving the digital message (e.g., a text message) containing the flight plan as if it were being received over the AFTN, and then decoding the submitted message and entering it into the system. When a modified flight plan is sent back to the wireless communication device, any changes may be highlighted when displayed by the application run on the wireless communication device, for example using a different color or different size or style of text.

An advantage in emulating AFTN messaging is that no change to the ATC automation system 13 (FIG. 1) would be needed, since the ATC automation system 13 already processes AFTN messages. From the standpoint of the ATC automation system 13, messages sent by the wireless communication device could be treated using the same process already in use for handling incoming AFTN messages, such as logic for correcting the order of received AFTN message packets.

The functions described above may be embodied in software and/or hardware run on the wireless communication device 16 (FIG. 1) and/or devices that are part of the ATC automation system 13 (FIG. 1). As used herein, software includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in series, parallel, massively parallel and other manners.

The software may be executed by, such as stored in, read, and run by, any suitable computer-readable medium, which herein refers to any suitable medium that participates in directly or indirectly providing signals, instructions, or data. The computer-readable medium may take forms, including, but not limited to, non-volatile media, volatile media, and/or transmission media.

In the flow diagrams, blocks and/or steps denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of obtaining flight plan clearance, the method comprising:
following submission of an initial flight plan, receiving in a wireless communication device a response regarding revisions and/or clearance of the initial flight plan; and
following the receiving, negotiating flight plan changes and/or clearance using the wireless communication device until an accepted flight plan clearance is obtained;
wherein the receiving and the negotiating include communicating with an air traffic control (ATC) automation system using digital messages.

2. The method of claim 1, wherein the receiving and the negotiating include communicating with the ATC automation system using text messages as the digital messages.

3. The method of claim 1, wherein the negotiating includes sending revised flight plan changes in a format corresponding to a format for flight plan negotiation messages received by the ATC automation system from communications other than through wireless communication devices.

4. The method of claim 1, wherein the negotiating includes sending revised flight plan changes in a format corresponding to an aeronautic fixed telecommunications network (AFTN) format.

5. The method of claim 1, wherein the negotiating includes sending a proposed revised flight plan from the wireless communication device to the ATC automation system.

6. The method of claim 1, further comprising, in connection with submission of the initial flight plan, associating the wireless communication device with the initial flight plan, for purposes of limiting the negotiating to being performed on only the wireless communication device, as opposed to other wireless communication devices.

7. A method of handling flan plan clearance, the method comprising:
receiving an initial flight plan;
associating a wireless communication device with the initial flight plan; and
following receiving and the associating, conducting subsequent flight plan clearance communications through digital messages sent to and received from the wireless communication device.

8. The method of claim 7, wherein the conducting includes performing a security check on incoming messages from the wireless communication device.

9. The method of claim 7, wherein the conducting include checking format of incoming messages from the wireless communication that request a change in the flight plan.

10. The method of claim 9, wherein the conducting further includes fixing formatting of the incoming messages that fail the checking format of the incoming messages.

11. The method of claim 7, wherein the conducting includes conducting the communications using text messages as the digital messages.

12. The method of claim 7, wherein the conducting includes sending to the wireless communication device and receiving from the wireless communication device formatted messages containing revisions to the initial flight plan.

13. The method of claim 7, wherein the conducting includes conducting the communications with a smartphone or tablet as the wireless communication device.

14. The method of claim 7, wherein the conducting includes limiting the number of requests for changes to the initial flight plan that can be sent from the wireless communication device.

15. The method of claim 7, wherein the associated includes associating with the initial flight plan a telephone number that is associated with the wireless communication device.
